(19) United States
(12) Patent Application Publication
(10) Pub. No.: US 2006/0198762 A1
(43) Pub. Date: Sep. 7, 2006

(54) Optical glucose sensor chip

(76) Inventors: Ikuo Uematsu, Yokohama-shi (JP); Ichiro Tono, Yokohama-shi (JP); Kayoko Oomiya, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/365,521

(22) Filed: Mar. 2, 2006

(30) Foreign Application Priority Data
Mar. 4, 2005 (JP) 2005-060441
Mar. 31, 2005 (JP) 2005-101375

(51) Int. Cl. G01N 21/00

(52) U.S. Cl. 422/82.11

(57) ABSTRACT

An optical glucose sensor chip comprises a glass substrate, a first optical element formed on a major face of the substrate for impinging light into the substrate, a second optical element formed on the major face of the substrate for emitting the light to the outside, and a glucose sensing membrane formed on the major face of the substrate situated between the first and second gratings. The glucose sensing membrane comprises a color developer, a first enzyme for oxidizing or reducing glucose, a second enzyme for generating a substance for developing the color developer by reacting with a product of the first enzyme, a film-forming polymer compound, and a cross-linking polymer compound.

### CROSS-REFERENCE TO RELATED APPLICATIONS

This application is based upon and claims the benefit of priority from prior Japanese Patent Applications No. 2005-060441, filed Mar. 4, 2005; and No. 2005-101375, filed Mar. 31, 2005, the entire contents of both of which are incorporated herein by reference.

### BACKGROUND OF THE INVENTION

1. Field of the Invention

The invention relates to an optical glucose sensor chip.

2. Description of the Related Art

An optical glucose sensor chip for low invasive blood glucose measurement has been developed for indirect measurements of blood glucose levels by extracting body fluids from subcutaneous tissues. The sensor chip has a structure comprising a glass substrate, a first grating formed on the surface of the substrate for introducing a light into the substrate, a second grating formed on the surface of the substrate for emitting the light from the substrate, and a glucose sensing membrane formed on the surface of the substrate so as to be situated between the first and second gratings. The glucose sensing membrane contains a color developer (for example 3,3′,5,5′-tetramethylbenzidine [TMBZ]), a first enzyme (for example glucose oxidase [GOD]) for oxidizing or reducing glucose, a second enzyme (for example peroxidase [POD]) for generating a substance for developing the color developer by reacting with a product by the first enzyme, and a film-forming polymer compound (for example cellulose derivatives such as carboxymethyl cellulose [CMC]).

When an electric field is applied by providing a sheet of gel between the skin and the sensing membrane using the glucose sensor chip having the structure as described above, glucose in the body fluid in the subcutaneous tissue arrives at the sensing membrane by permeating the skin. Then, a color is developed from TMBZ as the color developer in the sensing membrane due to a reaction of glucose with GOD and POD. When a light, for example laser light, impinges on the substrate and is allowed to refract at the surface of the substrate and at the first grating, the laser light is propagated into the interface between the substrate and the sensing membrane containing TMBZ, is refracted at the interface between the substrate and the second grating, and is received, for example, with a light-receiving element. The intensity of the received laser light becomes lower than the intensity (initial intensity) of the laser light received by the light-receiving element when the color developer does not emit light, due to light emission of the color developer in the glucose sensing membrane, and the concentration of glucose is sensed from the reduction ratio.

Possible methods for allowing glucose in the subcutaneous tissue fluid to arrive at the sensing membrane include a reverse iontophoresis method. In this iontophoresis method, an adaptor having a well is made to contact the skin, and the sensor chip is attached to the adaptor so that the sensing membrane of the adapter comes to the well side. Subsequently, the well is filled with an extraction medium containing water, glucose in the subcutaneous tissue fluid is extracted through the skin by applying a fine voltage from the outside, and the amount of glucose is sensed by allowing it to arrive at the sensing membrane. However, the following problems arise since an extraction medium containing water is used in the iontophoresis method.

This means that, since the sensing membrane of the glucose sensor chip contains a film-forming polymer compound such as carboxymethyl cellulose (CMC), which has a high molecular weight and is hardly soluble in water, as a binder, sensitivity of the sensor is maintained by suppressing the polymer from being dissolved at room temperature even when the extraction medium contains water. However, dissolution of the film-forming polymer compound (binder) is accelerated when the extraction medium is warmed. Accordingly, the color developer and enzymes are dissolved out of the sensing membrane, decreasing the sensitivity of the chip.

### BRIEF SUMMARY OF THE INVENTION

According to first aspect of the present invention, there is provided an optical glucose sensor chip, which comprises:

a substrate;

a first optical element formed on a major face of the substrate for impinging light into the substrate;

a second optical element formed on the major face of the substrate for emitting the light to the outside; and

a glucose sensing membrane formed on the major face of the substrate located between the first and second substrates,

wherein the glucose sensing membrane comprises a color developer, a first enzyme which oxidizes or reduces glucose, a second enzyme which generates a substance for developing the color developer by reacting with a product of the first enzyme, a film-forming polymer compound, and a cross-linking polymer compound.

According to second aspect of the present invention, there is provided an optical glucose sensor chip, which comprises:

a glass substrate;

a first optical element formed on a major face of the substrate for impinging light into the substrate;

a second optical element formed on the major face of the substrate for emitting the light to the outside;

a light-reflecting waveguide layer formed on a major face of the substrate including the first and second optical elements and made of a resin having a higher refractive index than the substrate; and

a glucose sensing membrane formed on the major face of the substrate located between the first and second substrates,

wherein the glucose sensing membrane comprises a color developer, a first enzyme which oxidizes or reduces glucose, a second enzyme which generates a substance for developing the color developer by reacting with a product of the first enzyme, a film-forming polymer compound, and a cross-linking polymer compound.

### BRIEF DESCRIPTION OF THE SEVERAL VIEWS OF THE DRAWING

FIG. 1 is a cross-sectional view showing a glucose sensor chip according to a first embodiment of the invention;

FIG. 2 is a cross-sectional view showing a glucose sensor chip according to a second embodiment of the invention;

FIG. 3 is a graph showing the sensitivity of the measurement of different amounts of glucose at 25° C. and 37° C., respectively, using a glucose sensor chip in Example 1; and

FIG. 4 is a graph showing the sensitivity of the measurement of the amount of glucose against changes of the NaCl concentration using each glucose sensor chip in Example 2.

### DETAILED DESCRIPTION OF THE INVENTION

An optical glucose sensor chip according to one embodiment of the invention will be described hereinafter in detail with reference to drawings.

### First Embodiment

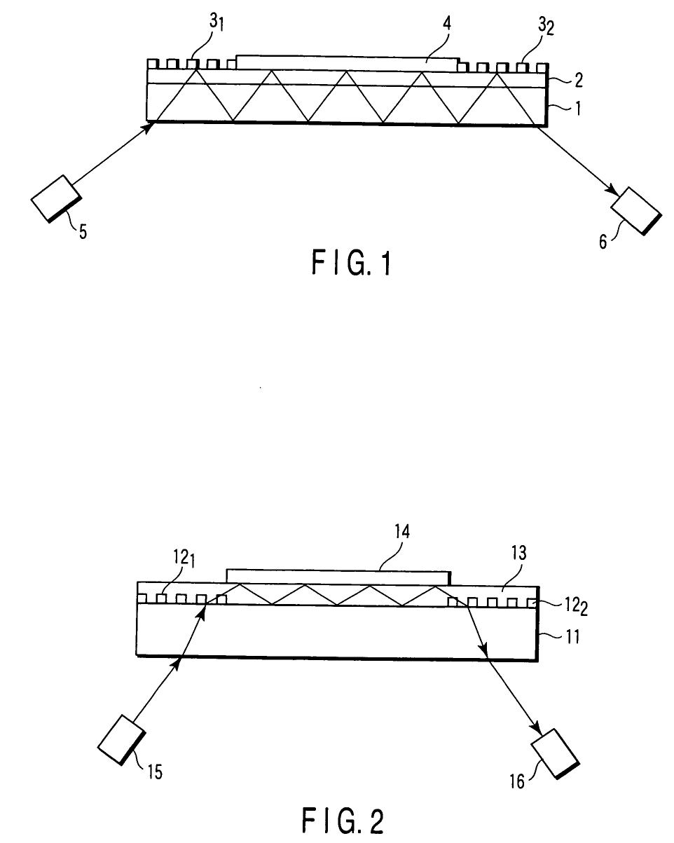

FIG. 1 is a cross sectional view showing a glucose sensor chip according to a first embodiment of the invention.

A glass substrate 1 has a SiO₂ surface layer 2 with a thickness of, for example, 3 nm or more on the major surface. First and second gratings 3₁ and 3₂ as first and second optical elements, respectively, are formed at near both ends of the SiO₂ surface layer 2. The fist grating 3₁ impinges a light into the substrate 1. The second grating 3₂ emits the light from the substrate 1 to the outside. The first and second optical elements may be replaced with prisms. The first and second gratings 3₁ and 3₂ are made of, for example, titanium oxide having a higher refractive index than the SiO₂ surface layer 2. A protective layer (not shown) having a lower refractive index than the refractive indices of the fist grating 3₁ and second grating 3₂ may be formed so as to cover the first and second gratings 3₁ and 3₂. The protective layer is made of, for example, a fluorinated resin that does not react with chemical solutions and test samples used.

A glucose sensing membrane 4 is formed on the SiO₂ surface layer 2 located between the first and second gratings 3₁ and 3₂. The glucose sensing membrane 4 is composed of a film forming polymer compound and a cross-linking polymer compound. The membrane maintains a color developer, and a first enzyme that oxidizes or reduces glucose and a second enzyme that generates a substance for developing the color developer by reacting with the product by the first enzyme so as to maintain the activities of the first and second enzymes in the membrane.

The first enzyme, second enzyme and color developer in the glucose sensing membrane 4 are used in combinations as shown in Table 1 below.

TABLE 1

| First enzyme | | Second enzyme | Coloring agent |
|---|---|---|---|
| Oxidizing | Glucose | Peroxidase | 3,3′,5,5′-tetramethylbenzidine |
| enzyme | oxidase | | N,N′-bis(2-hydroxy-3-sulfopropyl)tolidine |
| | | | 3,3′-diaminodenzidine |
| | Hexokinase | Glucose-6- | 3-(4,5-dimethyl-2-thiazolyl)-2,5-diphenyl- |
| | | phosphoric acid | 2H-tetrazolium bromide |
| | | dehydrogenase | 2-(4-rhodophenyl)-3-(2,4-dinitrophenyl)-5- |
| | | | (2,4-disulfophenyl)-2H-tetrazolium |
| | | | 3-3′-[3,3′-dimethoxy-(1,1′-biphenyl)-4,4′- |
| | | | diyl]bis(2,5-diphenyl)-2H-tetrazolium choloride |
| Reducing | Glucose | Phosphorus | Aminobenzoic acid |
| enzyme | dehydrogenase | molybdate | |

An example of the film-forming polymer compound contained in the glucose sensing membrane 4 is a cellulose-base polymer compound. Examples of the cellulose-base polymer compound available include ionic cellulose derivatives and non-ionic cellulose derivatives.

Examples of the ionic cellulose derivative include anionic cellulose derivatives and salt compounds thereof such as carboxymethyl cellulose, cellulose sulfate and salt compounds thereof; and cationic cellulose derivatives and salt compounds thereof including hydrochlorides such as chitin and chitosan hydrochlorides and salt compounds thereof. These compounds may be used alone or as a mixture thereof. Examples of the salt compounds include sodium salts and potassium salts.

Examples of the non-ionic cellulose derivative include alkyl cellulose such as methyl cellulose and ethyl cellulose; hydroxylalkyl cellulose such as hydroxyethyl cellulose and hydroxypropyl cellulose; hydroxyalkylalkyl cellulose such as hydroxypropylmethyl cellulose, hydroxypropylethyl cellulose, hydroxydiethyl cellulose and hydroxyethylmethyl cellulose; and micro-fibrilated cellulose. These cellulose derivatives may be used alone or as a mixture thereof.

Examples of the cross-linking polymer compound contained in the glucose sensing membrane 4 include copolymers of hydrophilic monomers having at least one functional group selected from hydroxyl, carboxyl, amino and ionic functional groups and hydrophobic monomers. It was confirmed in the experiments by the inventors that the preferable copolymer of the hydrophilic monomer and hydrophobic monomer is a copolymer between 2-methacryloyloxyethylphosphoryl choline and butyl methacrylate.

The cross-linking polymer compound is preferably contained in the glucose sensing membrane in a proportion of 10⁻⁴ to 10% by weight relative to the total composition of the glucose sensing membrane. The membrane structure of the membrane may be dissolved or collapsed to make it difficult to prevent the color developer and enzymes retained in voids of the membrane structure from being dissolved into an external medium, when the content of the cross-linking polymer compound is less than 10⁻⁴% by weight relative to the total amount of the composition. On the other hand, when the content of the cross-linking polymer compound exceeds 10% by weight, the contents of the color developer and enzymes in the glucose sensing membrane may be relatively reduced, degrading the sensitivity of the chip.

The glucose sensing membrane 4 permits polyethyleneglycol or ethyleneglycol to be additionally contained in the voids of the membrane structure in order to enhance water permeability. This serves for enhancing hydrophilicity to thereby increase the sensitivity of reactions when water is used as a medium for introducing glucose.

The action of the optical glucose sensor shown in FIG. 1 will be described below.

An adopter (not shown) having a perforation hole (well) is made to contact the test sample, for example the skin of a human body, and the sensor chip is attached to the adapter so that the glucose sensing membrane 4 is located at the well side. The adapter avoids the glucose sensing membrane 4 from directly contacting the test sample, and serves to enhance reproducibility of sensing. An extraction medium (for example water or physiological saline that is not directly reactive to the test sample and sensing membrane and is able to wet them) is filled into the space formed by the adapter, and an external fine voltage is applied to the test sample. Glucose in the subcutaneous tissue fluid is extracted into the extraction medium through the skin, and permeates the sensing membrane 4 from the extraction medium. When a combination of the first enzyme (oxidation or reduction enzyme), second enzyme and color developer includes glucose oxidase (GOD), peroxidase (POD) and 3,3′,5,5′-tetramethylbenzidine (TMBZ) as shown in Table 1, glucose permeated into the sensing membrane 4 is decomposed with GOD to generate hydrogen peroxide, and active oxygen is released by decomposing hydrogen peroxide with POD to develop a color of TMBZ. This means that the extent of color development of TMBZ changes depending on the amount of glucose.

Laser light impinges on the back side of the substrate 1 from a laser light source (for example a laser diode) 5 through a polarizing filter (not shown). The incident laser light is refracted at the interface between the SiO₂ surface layer 2 of the substrate 1 and the first grating 3₁ at the left side in the drawing, and is further refracted at the interface between the SiO₂ surface layer 2 and the glucose sensing membrane 4 containing the color-emitting color developer to propagate into the substrate 1 including the SiO₂ surface layer 2. The evanescent wave of the propagating light is absorbed in response to the degree of color development based on the amount of glucose in the glucose sensing membrane 4. The light propagating through the substrate 1 is emitted from the second grating 3₂ at the right side in the drawing, and is received by a light-receiving element (for example a photodiode) 6. The intensity of the received laser light becomes lower than the intensity of the light (initial intensity) received when the sensing membrane 4 is not emitting a light, and the amount of glucose can be sensed from the reduction ratio.

When the optical glucose sensor chip of the first embodiment is used for sensing the amount of glucose, the glucose sensing membrane 4 contains a cross-linking compound and is highly resistant to dissolution of the membrane. Accordingly, when glucose in the subcutaneous tissue fluid is extracted from the skin into the extraction medium containing water and permeated into the glucose sensing membrane 4, the membrane is not dissolved even by allowing warmed water (for example about 36° C.) to permeate into the sensing membrane 4 together with glucose to suppress the enzymes in the membrane from being dissolved out.

In particular, since a copolymer between a hydrophilic monomer having at least one group selected from hydroxyl, carboxyl, amino and ionic functional groups and a hydrophobic monomer is used as the cross-linking polymer compound, high water permeability may be maintained while keeping retention ability of water in the glucose sensing membrane due to the hydrophilic monomer in addition to high resistivity to dissolution of the membrane due to the hydrophilic monomer. Consequently, a color is sufficiently developed in response to the presence of glucose in the sensing membrane, and the membrane structure, retained substances under a warmed condition and enzymes may be reliably suppressed from being dissolved while maintaining high sensitivity.

Accordingly, the first embodiment provides an optical glucose sensor chip capable of sensing the amount glucose in the test sample for a long period of time with high sensitivity even under a warmed condition.

### Second Embodiment

FIG. 2 shows a cross-sectional view of an optical sensor chip according to a second embodiment of the invention.

First and second gratings 12₁ and 12₂ as first and second optical elements, respectively, are formed at near both ends on the major surface of a glass substrate 11. The first grating 12₁ impinges a light into the substrate 11. The second grating 12₂ emits the light from the substrate 11 to the outside. The first and second gratings 12₁ and 12₂ are made of, for example, titanium oxide having a higher refractive index than the substrate 11. A light-reflecting waveguide layer 13 made of a thermosetting or light-curable resin having a higher refractive index than the substrate 11 is formed on the major surface of the substrate 11 including the first and second gratings 12₁ and 12₂. The major surface of the light-reflecting waveguide layer 13 is formed to be parallel to the major surface of the substrate 11.

A glucose sensing membrane 14 is formed on the portion of the light-reflecting waveguide layer 13 located between the first and second gratings 12₁ and 12₂. The glucose sensing membrane 14 is composed of a membrane comprising a film-forming polymer compound and a cross-linking polymer compound. The membrane comprises a first enzyme for oxidizing or reducing glucose, a second enzyme for generating a substance that develops the color developer by reacting with the product by the first enzyme, and the color developer while the activity of the enzymes are maintained.

The light-reflecting waveguide layer 13 has a smooth surface, and preferably has a thickness of 10 μm or more, more preferably 10 to 200 μm. The light-reflecting waveguide layer having a thickness of 10 μm or more is able to suppress attenuation of light intensity during propagation of the light, and enables a laser light source as well as an LED to be used.

The first enzyme, second enzyme and color developer in the glucose sensing membrane 14 are used, for example, as a combination as shown in Table 1.

Examples of the film-forming polymer compound in the glucose sensing membrane 14 include cellulose-base polymer compound such as carboxymethyl cellulose and hydroxyl cellulose. It was confirmed in the experimentally by the inventors that a copolymer of 2-methacryloyloxyethyl phosphorylcholine and butyl methacrylate is particularly preferable as the copolymer between the hydrophilic monomer and hydrophobic monomer.

Examples of the cross-linking polymer compound in the glucose sensing membrane 14 include copolymers of hydrophilic monomers having at least one group selected from hydroxyl, carboxyl, amino and ionic functional groups, and hydrophobic monomers as described in the first embodiment.

The glucose sensing membrane preferably contains the cross-linking polymer compound in an amount of 10⁻⁴ to 10% by weight for the reasons described in the first embodiment.

The glucose sensing membrane 14 permits polyethyleneglycol to be contained for providing water permeability.

The action of the optical glucose sensor chip shown in FIG. 2 will be described below.

An adopter (not shown) having a perforation hole (well) is made to contact the test sample, for example the skin of the human body, and the sensor chip is attached to the adapter so that the glucose sensing membrane 14 is located at the well side. An extraction medium is filled into the well, and an external fine voltage is applied to the well. Glucose in the subcutaneous tissue fluid is extracted into the extraction medium through the skin, and permeates into the sensing membrane 14. When a combination of the first enzyme (oxidation or reduction enzyme), second enzyme and color developer comprises glucose oxidase (GOD), peroxidase (POD) and 3,3′,5,5′-tetramethylbenzidine (TMBZ) as shown in Table 1, glucose permeated into the sensing membrane 4 is decomposed by GOD to generate hydrogen peroxide, and active oxygen is released by decomposing hydrogen peroxide with POD to develop a color of TMBZ. This means that the extent of color development of TMBZ changes depending on the amount of glucose.

Laser light impinges on the back side of the substrate 11 from a laser light source (for example a laser diode) 15 through a polarizing filter (not shown). The incident laser light is refracted at the interface between major surface of the substrate 11 and the first grating 12₁ at the left side in the drawing to be impinged into the light-reflecting waveguide layer 13, and is further refracted at the interface between the light-reflecting waveguide layer 13 and the glucose sensing membrane 14 containing the color-emitting color developer to propagate into the light-reflecting waveguide layer 13. The evanescent wave of the propagating light is absorbed in response to the degree of color development based on the amount of glucose in the glucose sensing membrane 14. The light propagating through the light-reflecting waveguide layer 13 is emitted from the second grating 122 at the right side in the drawing, and is received with a light-receiving element (for example photodiode) 16. The intensity of the received laser light becomes lower than the intensity of the light (initial intensity) received when the sensing membrane 14 is not emitting a light, and the amount of glucose can be sensed from the reduction ratio.

When the optical glucose sensor chip of the second embodiment is used for sensing the amount of glucose, the glucose sensing membrane 14 contains a cross-linking compound and is highly resistant to dissolution of the membrane. Accordingly, when glucose in the subcutaneous tissue fluid is extracted from the skin into the extraction medium containing water and permeated into the glucose sensing membrane 14, the membrane is not dissolved by allowing warmed water (for example at about 36° C.) to permeate into the sensing membrane 14 together with glucose to suppress the enzymes in the membrane from being dissolved out. In particular, since a copolymer between a hydrophilic monomer having at least one group selected from hydroxyl, carboxyl, amino and ionic functional groups and a hydrophobic monomer is used as the cross-linking polymer compound, high water permeability may be maintained while keeping retention ability of water in the glucose sensing membrane due to the hydrophilic monomer in addition to high resistivity to dissolution of the membrane due to the hydrophilic monomer. Consequently, a color is sufficiently developed in response to the presence of glucose in the sensing membrane, and the membrane structure, retained substances under a warmed condition and enzymes may be reliably suppressed from being dissolved while maintaining high sensitivity.

Accordingly, the second embodiment provides an optical glucose sensor chip capable of sensing the amount glucose in the test sample for a long period with high sensitivity even under a warmed condition.

It is advantageous in the first and second embodiments to use a non-ionic cellulose derivative such as hydroxyethyl cellulose as the film-forming polymer compound blended in the sensing membrane.

Physical properties such as viscosity may change in accordance with the change of the salt concentration in the extraction medium by blending the ionic cellulose derivative such as carboxymethyl cellulose in the sensing membrane. Accordingly, sensitivity of sensing the amount of glucose in the test sample is fluctuated. However, the non-ionic cellulose derivative suppresses physical values such as viscosity from fluctuating when the concentrations of salts are changed in the extraction medium. Consequently, a sensing membrane, which does not exhibit salt concentration dependency of the sensing sensitivity of the amount of glucose in the test sample, may be designed.

Accordingly, the second embodiment provides an optical glucose sensor chip capable of sensing the amount of glucose in the test sample with a stable sensitivity even when the salt concentration in the extraction medium changes (for example the concentration of NaCl changes from 0.00001% by weight to 1% by weight), by blending the non-ionic cellulose derivative in the sensing membrane as the film-forming polymer compound.

Examples of the invention will be described hereinafter.

### EXAMPLE 1

Mixed and stirred to prepare 4000 μL of a coating solution for forming a glucose sensing membrane were 1436 μL of isopropyl alcohol (IPA), 956 μL of pure water, 210 μL of phosphate buffer solution (0.01 mol/L, pH 6.0), 60 μL of isopropyl alcohol solution (1% by volume) of polyethyleneglycol, 600 μL of isopropyl alcohol solution of 3,3′,5,5′-tetramethylbenzidine (TMBZ: 1 mg/mL), 640 μL of aqueous solution (2% by weight) of carboxymethyl cellulose, 8 μL of aqueous solution (1% by weight) of a cross-linking polymer (a copolymer of 2-methacryloyloxyethyl phosphorylcholine and butyl methacrylate), 0.67 mg/mL of an aqueous peroxidase (POD) solution (dissolved in 0.01 mole/L of phosphate buffer solution, pH 6.0), and 5.33 mg/mL of an aqueous glucose oxidase (GOD) solution (dissolved in 0.01 mole/L of phosphate buffer solution, pH 6.0).

Subsequently, a non-alkaline glass substrate having a SiO₂ surface layer with a thickness of 10 nm on the major surface and a refractive index of 1.52 was prepared, and a titanium oxide film with a refractive index of 2.2 to 2.4 and a thickness of 50 nm was deposited on the SiO₂ surface later on the major face by sputtering. Then, after applying a resist layer to the titanium oxide film and drying the resist layer, a resist pattern was formed by lithography. Subsequently, the titanium oxide film was selectively removed by reactive ion etching (RIE) using the resist pattern as a mask to form first and second gratings on the surface at near both ends of the SiO₂ surface layer, respectively. The resist pattern was removed by ashing thereafter.

Then, after washing the substrate by oxygen RIE in a dry state, the substrate was cut into chips with a size of 17 mm×6.5 mm by dicing. Then, 8 μL of the coating solution for forming the glucose sensing membrane was dripped on the surface of the sensing membrane forming area of the substrate located between the first and second gratings. A porous (water-permeable) glucose sensing membrane with a thickness of 0.8 μm was formed by vacuum drying while purging an inert gas to produce an optical glucose chip as shown in FIG. 1. Drops of the coating solution for forming the glucose sensing membrane had the following composition:

phosphate buffer solution: 0.000525 mole/L

PEG: 0.15% by volume

TMBZ: 0.15 mg/dl

POD: 0.0015 mg/mL

GOD: 0.012 mg/mL

CMC: 0.32% by weight

copolymer of 2-methacryloyloxyethyl phosphorylcholine and butyl methacrylate: 0.002% by weight

An adopter having a perforation holes (well) was made to contact an appropriate flat plate (for example a glass plate), and the well was partitioned by attaching the sensor chip to the adaptor so that the glucose sensing membrane is situated at the well side. Aqueous solutions containing 0 mg/dL (no glucose), 0.05 mg/dL, 0.2 mg/dL, 0.5 mg/dL and 1 mg/dL of glucose were filled in respective wells to permit the aqueous solution to permeate into the sensing membrane at 25° C. and 37° C. The glucose sensing membrane retains glucose oxidase (GOD), peroxidase (POD) and 3,3′,5,5′-tetramethylbenzidine (TMBZ) while activities of the enzymes are maintained. As a result, permeated glucose was decomposed with GOD to generate hydrogen peroxide, which was decomposed with POD to generate active oxygen, and TMBZ was developed with this active oxygen. It was actually confirmed that the degree of color development was changed depending on the amount of glucose.

Laser light was made to impinge on the back face of the substrate 1 through a polarizing plate from a laser diode 5 as shown in FIG. 1 by filling the well with water containing no glucose (at temperatures of 25° C. and 37° C.). The incident laser was refracted at the interface between the SiO₂ surface layer 2 and first grating 3₁ on the substrate 1, and further refracted at the interface between the SiO₂ surface layer 2 and glucose sensing membrane 4 containing a light-emitting color developer to propagate the light into the substrate 1 including the SiO₂ surface layer 2. The propagated laser light was refracted at the interface between the second grating 32 and substrate 1, and was received by a photodiode array 6 to sense the light intensity (an initial light intensity).

The laser light was refracted at the interface between the SiO₂ surface layer 2 and the glucose sensing membrane 4 containing the developer by the same method as described above by filling the well with water containing glucose (at temperatures of 25° C. and 37° C.). The refracted laser light was allowed to propagate into the substrate 1 including the SiO₂ surface layer 2 to sense the intensity of the laser light (measured light intensity).

Reduction ratios (sensitivity) were determined by the following equation using the initial light intensity and measured light intensity obtained at 25° C. and 37° C. using the glucose sensor chip.
Reduction ratio (%)=[(initial light intensity−measured light intensity)]/initial light intensity]×100

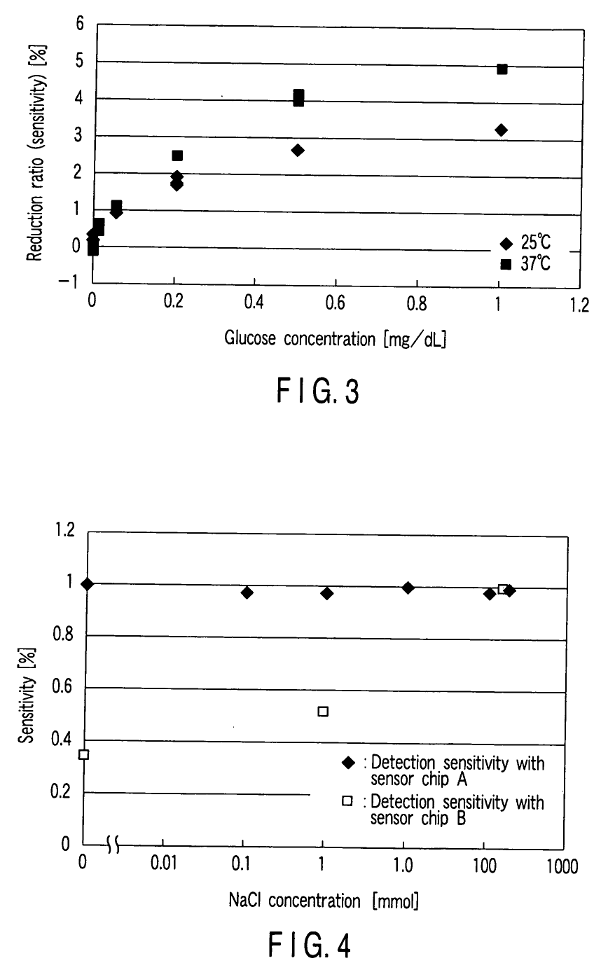

The results are shown in FIG. 3.

FIG. 3 shows that the sensitivity of the sensor chip in Example 1 is dependent on the glucose concentration in the concentration range of 0.05 to 1.0 mg/dL, and the sensitivity is constant at the measuring temperature in the range of 25 to 37° C. This means that sensing of glucose in the test sample is possible with high sensitivity even when the sample is warmed.

### EXAMPLE 2

A optical glucose sensor chip (referred to sensor chip A hereinafter) as shown in FIG. 1 was produced by forming the glucose sensing membrane as described in Example 1, except that hydroxyethyl cellulose (HEC) was blended in the drops of the coating solution for forming the glucose sensing membrane in a proportion of 0.32% by weight.

Sensitivity against the NaCl concentration was determined by the same method as in Example 1, except that the sensor chip A obtained and the glucose sensor chip obtained in Example 1 (referred to sensor chip B hereinafter) were used, and aqueous solutions (37° C.) containing 0.25 mg/dL of glucose and varying concentrations of NaCl (0 to 154 mmol) were filled in the well. The results are shown in FIG. 4.

FIG. 4 shows that sensitivity of sensor chip B, which has a sensing membrane containing carboxymethyl cellulose (CMC) as a film-forming polymer compound, varies depending on the NaCl concentration in a NaCl concentration range of 0 to 154 mmol.

Conversely, it was shown that sensitivity of sensor chip A, which has the sensing membrane containing hydroxyethyl cellulose (HEC) as the film- forming polymer compound, is constant independent of the NaCl concentration in a NaCl concentration range of 0 to 154 mmol. This means that stable sensing of the amount of glucose in the test sample by sensor chip A is possible even when the NaCl concentration changes.

The glucose sensor chip shown in FIG. 2, which has a light-reflecting waveguide layer comprising a thermosetting resin or a light-curable resin with a higher refractive index than the substrate, was also able to sense the amount of glucose in a warmed test sample with high sensitivity as in Example 1, and was also able to sense the amount of glucose in a test sample with stable sensitivity even when the NaCl concentration (salt concentration) changes as in Example 2.

While the first enzyme, second enzyme and color developer are added by selecting only one material for respective compounds in the embodiments and examples above, each compound may be a mixture of a plurality of materials depending on the object of applications. The cross-linking polymer compound and film-forming polymer compound may be mixtures of a plurality of respective polymers depending on the object of applications within the range of the spirit of the invention.

While a glass was used as the substrate in the embodiments above, the material is not particularly restricted so long as the material has a characteristic capable of propagating and permeating the light. Examples of the material available for the substrate include single crystals or any resin materials such as thermosetting resin materials, thermoplastic resin materials and light-curable resin materials.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical glucose sensor chip, which comprises:
a substrate;
a first optical element formed on a major face of the substrate for impinging light into the substrate;
a second optical element formed on the major face of the substrate for emitting the light to the outside; and
a glucose sensing membrane formed on the major face of the substrate located between the first and second substrates,
wherein the glucose sensing membrane comprises a color developer, a first enzyme which oxidizes or reduces glucose, a second enzyme which generates a substance for developing the color developer by reacting with a product of the first enzyme, a film-forming polymer compound, and a cross-linking polymer compound.

2. The optical glucose sensor chip according to claim 1, wherein the first and second optical elements are gratings, respectively.

3. The optical glucose sensor chip according to claim 2, wherein the grating is made of titanium oxide.

4. The optical glucose sensor chip according to claim 1, wherein the cross-linking polymer compound is a copolymer of a hydrophilic monomer and a hydrophobic monomer.

5. The optical glucose sensor chip according to claim 1, wherein the cross-linking polymer compound is a copolymer of a hydrophilic monomer having at least one group selected from a hydroxyl group, a carboxyl group, an amino group and an ionic functional group with a hydrophobic monomer.

6. The optical glucose sensor chip according to claim 4, wherein the copolymer of the hydrophilic monomer and hydrophobic monomer is a copolymer of 2-methacryloyloxyethyl phosphorylcholine and butyl methacrylate.

7. The optical glucose sensor chip according to claim 1, wherein the glucose sensing membrane further contains polyethyleneglycol for endowing the membrane with water permeability.

8. The optical glucose sensor chip according to claim 1, wherein the first enzyme is glucose oxidase, the second enzyme is peroxidase, and the color developer is at least one of 3,3′,5,5′-tetramethylbenjidine and N,N′-bis(2-hydroxy-3-sulfopropyl)tolidine.

9. The optical glucose sensor chip according to claim 1, wherein the film-forming polymer compound is a non-ionic cellulose derivative.

10. The optical glucose sensor chip according to claim 9, wherein the non-ionic cellulose derivative is at least one compound selected from the group consisting of alkyl cellulose, hydroxylalkyl cellulose and hydroxylalkylalkyl cellulose.

11. An optical glucose sensor chip, which comprises:
a glass substrate;
a first optical element formed on a major face of the substrate for impinging light into the substrate;
a second optical element formed on the major face of the substrate for emitting the light to the outside;
a light-reflecting waveguide layer formed on a major face of the substrate including the first and second optical elements and made of a resin having a higher refractive index than the substrate; and
a glucose sensing membrane formed on the major face of the substrate located between the first and second substrates,
wherein the glucose sensing membrane comprises a color developer, a first enzyme which oxidizes or reduces glucose, a second enzyme which generates a substance for developing the color developer by reacting with a product of the first enzyme, a film-forming polymer compound, and a cross-linking polymer compound.

12. The optical glucose sensor according to claim 11, wherein the first and second optical elements are gratings, respectively.

13. The optical glucose sensor chip according to claim 12, wherein the grating is made of titanium oxide.

14. The optical glucose sensor chip according to claim 11, wherein the cross-linking polymer compound is a copolymer of a hydrophilic monomer and a hydrophobic monomer.

15. The optical glucose sensor chip according to claim 11, wherein the cross-linking polymer compound is a copolymer of a hydrophilic monomer having at least one group selected from a hydroxyl group, a carboxyl group, an amino group and an ionic functional group with a hydrophobic monomer.

16. The optical glucose sensor chip according to claim 14, wherein the copolymer of the hydrophilic monomer and hydrophobic monomer is a copolymer of 2-methacryloyloxyethyl phosphorylcholine and butyl methacrylate.

17. The optical glucose sensor chip according to claim 11, wherein the glucose sensing membrane further contains polyethyleneglycol for endowing the membrane with water permeability.

18. The optical glucose sensor chip according to claim 11, wherein the first enzyme is glucose oxidase, the second enzyme is peroxidase, and the color developer is at least one of 3,3′,5,5′-tetramethylbenjidine and N,N′-bis(2-hydroxy-3-sulfopropyl)tolidine.

19. The optical glucose sensor chip according to claim 11, wherein the film-forming polymer compound is a non-ionic cellulose derivative.

20. The optical glucose sensor chip according to claim 19, wherein the non-ionic cellulose derivative is at least one compound selected from the group consisting of alkyl cellulose, hydroxylalkyl cellulose and hydroxylalkylalkyl cellulose.
